(19) United States
(12) Patent Application Publication
(10) Pub. No.: US 2024/0351369 A1
(43) Pub. Date: Oct. 24, 2024

(54) MECANUM WHEEL WITH EASILY REPLACEABLE ROLLERS

(71) Applicant: WHEEL.ME AS, Oslo (NO)

(72) Inventor: Andreas BLOM-BAKKE, Asker (NO)

(21) Appl. No.: 18/683,657

(22) PCT Filed: Aug. 16, 2022
(86) PCT No.: PCT/EP2022/072832

§ 371 Date: Feb. 14, 2024

(30) Foreign Application Priority Data
Aug. 19, 2021 (NO) 20210995

(51) Int. Cl. B60B 19/00; B60B 19/12

(52) U.S. Cl. CPC B60B 19/003; B60B 19/12

(57) ABSTRACT

The invention describes a mecanum wheel comprising a plurality of rollers each with a rolling surface and an axel and a wheel frame for mounting the rollers with mounting units holding respective axel ends of each roller. Each mounting unit comprise a mounting unit recess with an opening, wherein the mounting unit recess interacts with the respective axel end for locking the roller against movements in directions having a component radially inwards. Each mounting unit further comprise a rebounding roller retaining structure positioned at least partly inside an insertion path causing resistance when the axel end is pushed or pulled past the roller retaining structure into, and out from, a resting position in the mounting unit recess, thus preventing unintended release in a radial outward directed component.

### FIELD OF INVENTION

The invention relates to mecanum wheels, more specifically the invention relates to a mounting unit for fastening the rollers on a mecanum wheel.

### BACKGROUND

The applicant has previously developed a rolling device capable of being integrated in devices, such as a piece of furniture, a movable wall etc., for moving the device along a surface. The rolling device facilitates the moving of an object and can be used by everyone regardless of physical condition and capacity to lift different devices in which the rolling device is integrated. This device is described in Norwegian U.S. Pat. No. 316,760 B 1.

The rolling device of NO 316760 B 1 comprises a cylindrical sleeve device for mounting in, for example, the leg of a piece of furniture, and a piston that is movably arranged in the cylindrical sleeve device. A ball-shaped or spherical wheel is arranged in the piston. The piston is movable, with the aid of a click system comprising a spring, between an upper position and a lower position. When the piston is in the lower position, the piece of furniture can be rolled across the floor it is standing on, whilst when the piston is in the upper position, the wheel is inside the cylindrical sleeve device and the leg of the piece of furniture, in which the rolling device is arranged, thus stands on the floor. The piece of furniture thus stands in the desired position without rolling inadvertently across the floor when small forces are applied to the piece of furniture. The solution is completely mechanical.

In a further version as described in WO 2018138320, the applicant has evolved the concept of the rolling device further. WO 2018138320 presents a rolling device for arrangement for autonomously moving a device from a first position to a second position along a surface. The rolling device controls the movements of a rolling element according to position acquisitions and given position and movement instructions. The rolling element may have a set or fixed vertical position relative to the rolling device or may be arranged for displacement between a retracted position where the wheel element is prevented from moving along a surface and an extended position where the wheel element is prepared for movement along the surface, as described in EP 3102429 and NO 316760 B 1. Such a rolling device can be fitted with a mecanum wheel.

Mecanum wheels have been in use for a number of decades and are widely used for robotic movement. Mecanum wheels have a configuration allowing movement in any direction, and it is a conventional wheel with a series of rollers attached to its circumference. These rollers may typically each have an axis of rotation at 45° to the plane of the wheel and at 45° to a line through the centre of the roller parallel to the axis of rotation of the wheel but may of course also be arranged with axis of rotation having other inclinations than 45°.

During normal use the forces acting on a roller 2 mounted on a mecanum wheel 1 will always have a component radially towards the center of the mecanum wheel and will also have an axial component as indicated by arrows in FIG. 8. However, apart from centrifugal forces and G-forces originating from bumps and high velocities there are no forces to speak of, acting radially outward from the wheel. Therefore, it is possible to simplify the ordinary cumbersome nut and bolt fixture of the rollers and replace it with structural features locking the rollers against movements in an axial and radial inwards direction and use a simpler ‘quick release’ mechanism for handling the minor forces acting radially outwards.

One problem relating to mecanum wheels is that the rollers wears down quickly due to the angle of the rollers. Consequently, a lot of down time is caused by replacing rollers. The industry needs an easy way to replace the rollers and the current invention provide at least a partial solution to this problem.

### SUMMARY OF THE INVENTION

The invention describes a mecanum wheel 1 comprising a plurality of rollers 2, each roller has a rolling surface and an axel with axel ends protruding from each side of the rolling surface in the longitudinal direction of the roller. The axel end and has an axial stopper surface largely perpendicular to the axel. The mecanum wheel further comprises a wheel frame for mounting the rollers with mounting units arranged for holding respective axel ends of each roller. Each mounting unit comprises a mounting unit recess, a mounting unit stopper surface and a rebounding roller retaining structure. The mounting unit recess comprises an opening for inserting an axel end, wherein the mounting unit recess interacts with the respective axel end for structurally locking the roller against movements relative to the wheel frame in directions having a component radially inwards of the mecanum wheel. The mounting unit stopper surface is largely perpendicular to the axel and interacts with the axial stopper surface for locking the roller against movements relative to the wheel frame in directions along the axis of the roller. The rebounding roller retaining structure is positioned at least partly inside an insertion path of the respective axel end and causes resistance when the axel end is pushed past the roller retaining structure into, and out from, a resting position in the mounting unit recess, thus preventing unintended release of the roller caused by forces having a component directed radially outward of the mecanum wheel.

In one embodiment of the invention the axel is fixed to the rolling surface of the roller.

In another embodiment of the invention the rollers have an axel around which the rolling surface is rotating.

In yet another embodiment of the invention the rebounding roller retaining structure comprise a holding structure mounted on a deflective arm fixed to the mounting unit mating with a reciprocal holding structure on the end surface of the corresponding axel end.

In yet another embodiment of the invention the rebounding roller retaining structure is a narrow neck positioned partly inside the opening of the recess adapted to receive the axel end of a roller allowing the axel end to be pushed past the narrow neck and rest in the bottom of the recess.

In yet another embodiment of the invention the rebounding roller retaining structure comprises a resilient material.

In yet another embodiment of the invention the rebounding roller retaining structure is a ball positioned on an inward facing outer side of the recess and being pretensioned by a spring, wherein the ball mates with a hollow structure on the end surface of the axel end.

In yet another embodiment of the invention the mounting unit recess is a U-shape structure for receiving the axel end.

In yet another embodiment of the invention both axel ends of each roller comprises a gripping zone for robotic removal of the roller from the roller mounting units.

In yet another embodiment of the invention the deflective arm is provided with a finger grip to ease manual release of the roller.

In yet another embodiment of the invention the end surface of both axel ends of each roller comprises a gripping zone for robotic removal of the roller from the roller mounting units.

In yet another embodiment of the invention the axial stopper surface is the outward facing largely vertical end surface of the axial end interacting with an inward facing vertical stopper surface on an outer side of the recess, wherein the vertical stopper surface constitutes the mounting unit stopper surface.

In yet another embodiment of the invention the axial stopper surface is a flange at the outward facing inner side of the axial end interacting with an inward facing vertical inner rim of the recess, wherein the vertical inner rim constitutes the mounting unit stopper surface.

In a second aspect of the invention a rolling device for movement along a surface is described. The rolling device comprises a housing arranged for attachment to the device, a mecanum wheel according to claims 1-12 and driving means.

### BRIEF DESCRIPTION OF THE DRAWINGS

The invention will now be described in more detail by reference to the accompanying figures. The same numeral on different drawings refer to the same feature.

FIG. 1a shows a mecanum wheel of prior art.

FIG. 1b shows a rolling device with a mecanum wheel

FIG. 2 shows a mecanum wheel with replaceable rollers according to an embodiment of the invention

FIG. 3 shows a roller according to another embodiment of the invention viewed from the end of an axel.

FIG. 4 shows the roller of FIG. 3 from the side.

FIG. 5 shows the roller inserted in an embodiment of the rebounding roller retaining structure on one side and in a slot on the other side.

FIG. 6 shows the roller inserted in an embodiment of the rebounding roller retaining structure

FIGS. 7a and b shows two embodiments of the insertion path.

FIG. 8 indicates the direction of the forces acting on a roller mounted on a mecanum wheel

### DETAILED DESCRIPTION

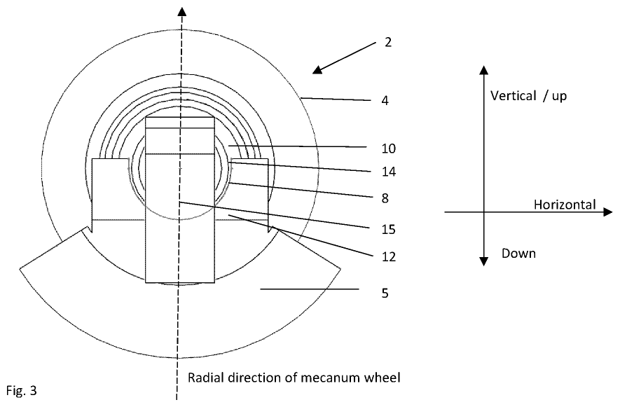

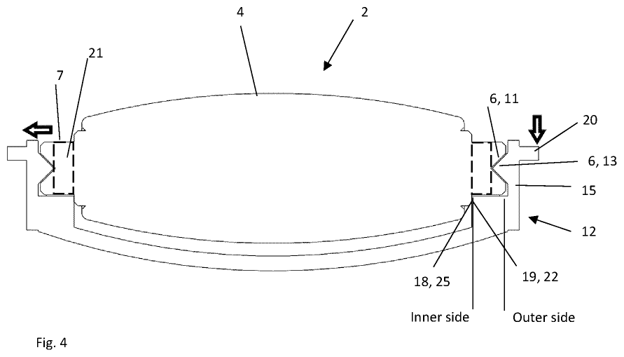

In this text the important directions are radially outward and radially inward of the mecanum wheel. The peripheral wheel plane is in this text a cylindrical plane along the outer rim of the mecanum wheel with the central axis coinciding with the axis of the mecanum wheel. When describing a roller and associated mounting unit up and down and vertical and horizontal are as seen in FIG. 3 and inner side of the mounting unit is toward the center of the roller and outer side is towards the rim of the mecanum wheel as indicated in FIG. 4.

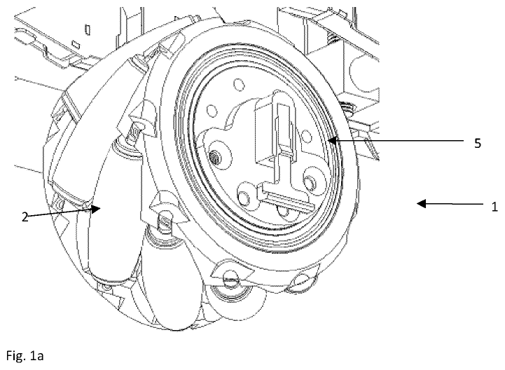

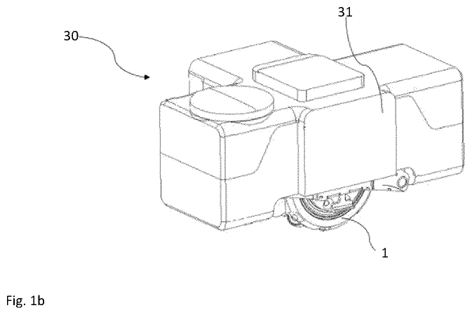

The invention is primarily directed towards mecanum wheels but can also conceivably be used in omnidirectional wheels. A mecanum wheel according to prior art is shown in FIG. 1a. A rolling surface 4 of a roller 2 must be positioned in the peripheral wheel plane of the wheel. This is always true in a mecanum wheel. The rolling surface 4 of the roller 2 is the surface that rolls on the ground or floor.

FIG. 1b shows a rolling device 30 for movement along a surface comprising a mecanum wheel 1 according to the invention. Several rolling devices can be linked together. Each rolling device 30 comprises in some embodiments driving means, communication means, and sensors for autonomous operation when controlled by a central controller unit.

The rolling device 30 may comprise a control unit for controlling the rolling device. The control unit can receive control signals for operation of the first and/or second drive motor from a remote control, computer, cell phone or by voice-activation. It is also possible that the control unit comprises software for autonomous control of the rolling device.

The rolling device 30 may comprise or be arranged in a housing 31. The housing may be arranged to enclose some of, all or most of the parts of the rolling device, such as wheel axle, the wheel, the motor and possibly means for extending and retracting the wheel. The rolling device may be arranged in the housing 31 in such a way that in the extended position at least a portion of the wheel 1 projects outside the housing 31.

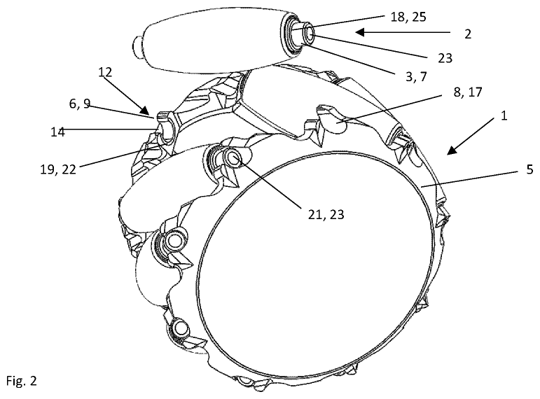

The mecanum wheel 1 according to the invention comprises a plurality of rollers 2. Each roller has an axel 3 with axel ends 7 protruding from a rolling surface 4 in an axial direction as seen in FIGS. 2 and 4. The axel ends 7 protrudes from the rolling surfaces in an axial direction to enable interaction with the mounting unit recess 8. The axel ends comprise an end surface 23 largely perpendicular to the axel and an axial stopper surface 18 largely perpendicular to the axel 3 as seen in FIGS. 2 and 4. The rollers are mounted on a wheel frame 5 by mounting units 12, which are arranged with one pair of mounting units 12 for each roller.

A mounting unit 12 comprises a mounting unit recess 8 with an opening for receiving the axel end 7. The mounting unit recess 8 is mating with respective axel ends 7 on the end of each side of the axel 3 for structurally locking the roller 2 at least for movements in directions having a component radially inwards of the mecanum wheel 1.

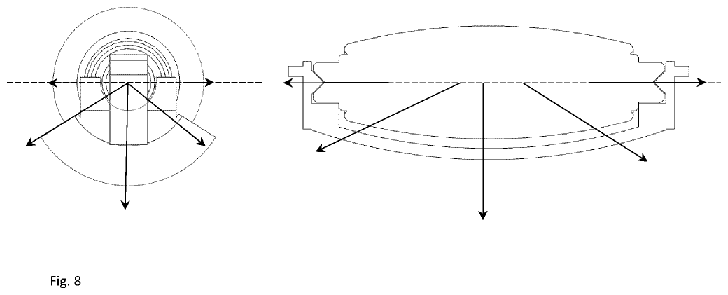

The mounting unit further comprise a mounting unit stopper surface 19 largely perpendicular to the axel 3 interacting with the axial stopper surface 18 for locking the roller 2 against movements relative to the wheel frame 5 in directions along the axis of the roller 2. Examples of stopper surfaces 18, 19 are shown in FIGS. 2, 4 and 6. The directions of the mentioned movements are indicated in FIG. 8.

As can be seen in FIGS. 2, 3 and 4, the mounting unit 12 further comprise a rebounding roller retaining structure 6 preventing unintended release of the roller 2 in directions not being locked by the respective mounting unit recesses 8 interacting with the respective axel ends 7 of the axel 3. A roller is held in position on the mecanum wheel by two mounting units.

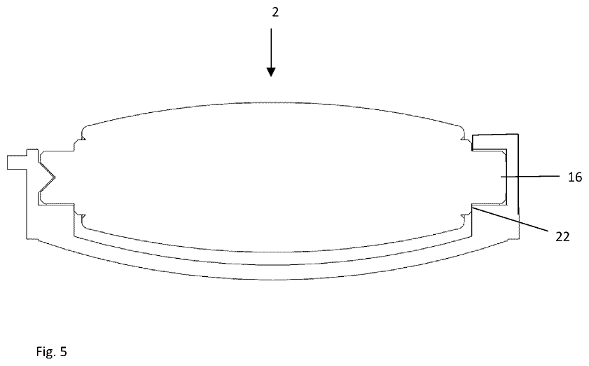

In another embodiment shown in FIG. 5 the roller is held in position by one mounting unit and one axially directed slot 16 into which one of the axel ends 7 can be inserted in a largely axial movement, before the other axel end 7 is inserted into the mounting unit recess 8 on the mounting unit 12 on the opposite side of the slot 16.

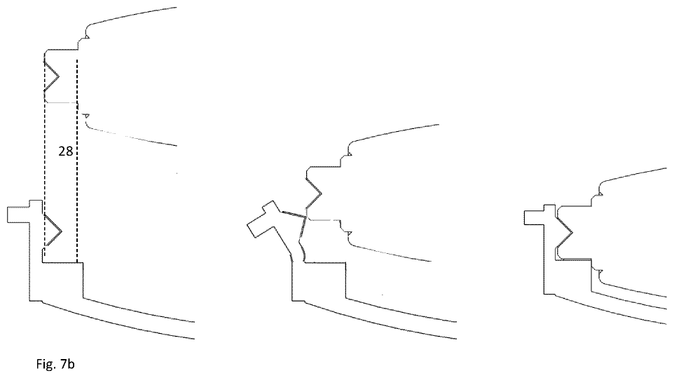

Preferably, it is possible to insert and remove the roller 2 without any other action being necessary like e.g. pushing or pulling a grip, button or handle. This is most easily achieved by a rebounding roller retaining structure 6 at least partly positioned inside the mounting unit recess 8 or opening 14. This is equivalent to the roller retaining structure being positioned in an insertion path 28 of the respective axial ends 7. Embodiments of an insertion path 28 is indicated by dotted lines shown in FIGS. 7a and b. The insertion path is the path the respective axel ends 7 follows when inserted into the respective recesses 8 and comprises the recess itself and the opening 14.

The purpose of the rebounding roller retaining structure 6 is to provide a resistance when forces are pushing/pulling the roller in or out of the mounting unit recesses 8. The rebounding roller retaining structure 6 can obtain its rebounding characteristics by a deflective arm, a flexible material or a structure pretensioned by a spring. The force needed to counteract the pretensioning of the pretensioned structure, compressing the flexible material or bending the deflective arm combined with frictional forces will provide the resistance needed to hold the roller 2 in position.

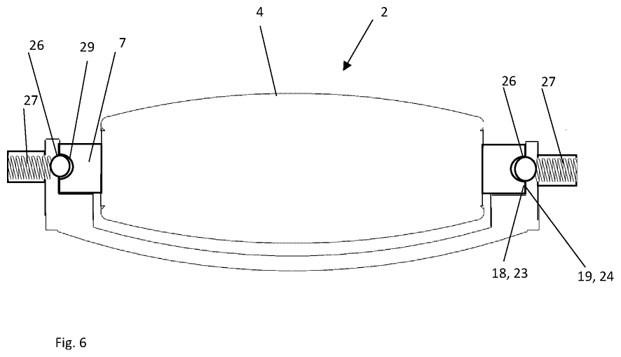

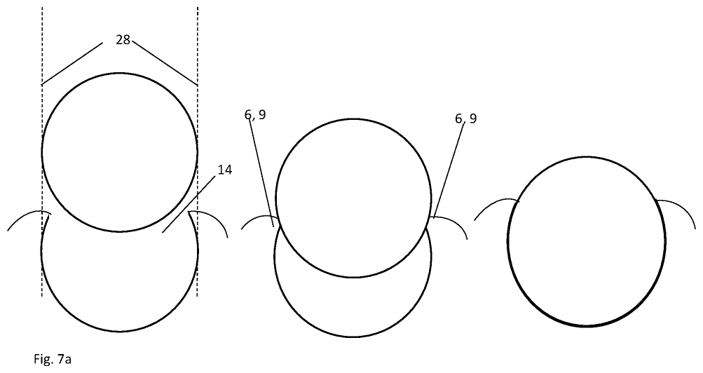

In one embodiment shown in FIG. 6 the rebounding roller retaining structure is a ball 26 pretensioned by a spring 27 and mating with a hollow structure 29 in the end surface 23 of the axel.

By ‘structurally locked’ against movements we mean that it is the structure and properties of the material that prevents movements. The roller may have an axel 3 that is fixed to the rolling surface 4 or may have an axel that is rotating relative to the rolling surface 4. Bearings 10 can be mounted between the axel and the rolling surface 4 or between the axel 3 and the mounting unit. Low friction material and/or lubrication can be used instead of bearings.

In an embodiment, shown in FIG. 2, the rebounding roller retaining structure 6 comprises a narrow neck 9 by the opening 14 of the mounting unit recess 8, which in this embodiment is a U-shape structure 17. The narrow neck 9 is made from a resilient material adapted to receive the axel end 7 of a roller 2 allowing the axel to be pushed past the neck 9 and rest in the bottom of the U-shape structure 17.

An embodiment of the rebounding roller retaining structure 6 is shown in FIGS. 3 and 4. FIG. 3 shows a mounting unit recess 8 for receiving an axel end 7 of a roller 2. Close to the mounting unit recess 8 is a deflective arm 15 attached to the mounting unit 12, appearing to be in front of the mounting unit recess 8 in FIG. 3. The deflective arm 15 of FIG. 3 deflects in an axial direction and is provided with a holding structure 13 which interacts with a reciprocal holding structure 11 on the axel end 7. In one embodiment the deflective arm 15 is provided with a finger grip 20 to ease manual release of the roller 4. Arrows in FIG. 4 indicate possible directions to push for releasing the roller.

In an embodiment shown in FIGS. 2 and 7a, the axial stopper surface 18 is a flange 25 on the inner side of the axel end 7 stopping against a largely vertical inner rim 22 peripheral to the recess 8 (FIG. 2) or slot 16 (FIG. 5).

In an embodiment shown in FIG. 6, the axial stopper surface 18 is a largely vertical end surface 23 of the axel end 7 stopping against a vertical stopper surface 24 on the outer side of the recess 8 constituting the mounting unit stopper surface 19 on the mounting unit 12. The mentioned surfaces are largely perpendicular to the axis of the roller.

In the embodiments seen in FIGS. 2 and 4 the removal of the roller 2 can be done symmetrically with both axial ends moving in parallel and with no action needed except from applying a force on the roller in a radial direction outward. The roller may then be removed by a robotic arm clutching a gripping zone 21 on each axial end as indicated in FIG. 4. In the embodiment shown in FIG. 2 the gripping zone 21 is positioned on the end surfaces 23 of the axel ends 7 and robotic arms may clutch the gripping zone 21 in an axial movement. For better grip, a gripping structure may be provided in the gripping zone 21.

### INVENTORY

1 Mecanum wheel
2 Roller
3 Axel
4 Rolling surface
5 Wheel frame
6 Rebounding roller retaining structure
7 Axel end
8 Mounting unit recess
9 Narrow neck
10 Bearing
11 Reciprocal holding structure (at an axel end 7)
12 Mounting unit
13 Holding structure (on deflective arm)
14 Opening
15 Deflective arm
16 Slot
17 U-shape structure
18 Axial stopper surface
19 Mounting unit stopper surface
Finger grip
21 Gripping zone
22 Vertical inner rim of recess
23 End surface of the axel
24 Vertical stopper surface of recess
25 Flange of axel end
26 Ball
27 Spring
28 Insertion path
29 Hollow structure
30 Rolling device
31 Housing

1. A mecanum wheel comprising:
a plurality of rollers each with a rolling surface and an axel with axel ends protruding from each side of the rolling surface in the longitudinal direction of the roller and having an axial stopper surface largely perpendicular to the axel,
a wheel frame for mounting the rollers with mounting units, arranged for holding respective axel ends of each roller, wherein each mounting unit comprising:
a mounting unit recess with an opening for inserting an axel end, wherein the mounting unit recess interacts with the respective axel end for structurally locking the roller against movements relative to the wheel frame in directions having a component radially inwards of the mecanum wheel, a mounting unit stopper surface largely perpendicular to the axel interacting with the axial stopper surface for locking the roller against movements relative to the wheel frame in directions along the axis of the roller, a rebounding roller retaining structure positioned at least partly inside an insertion path of the respective axel end causing resistance when the axel end is pushed or pulled past the roller retaining structure into, and out from, a resting position in the mounting unit recess, thus preventing unintended release of the roller caused by forces having a component directed radially outward of the mecanum wheel.

2. Mecanum wheel according to claim 1, wherein the axel is fixed to the rolling surface of the roller.

3. Mecanum wheel according to claim 1, wherein the rollers have an axel around which the rolling surface is rotating.

4. Mecanum wheel according to claim 1, wherein the rebounding roller retaining structure comprise a holding structure mounted on a deflective arm fixed to the mounting unit mating with a reciprocal holding structure on the end surface of the corresponding axel end.

5. Mecanum wheel according to claim 1, wherein the rebounding roller retaining structure is a narrow neck positioned partly inside the opening of the recess to receive the axel end of a roller allowing the axel end to be pushed past the narrow neck and rest in the bottom of the recess.

6. Mecanum Wheel according to claim 5, wherein the narrow neck comprises a resilient material.

7. Mecanum wheel according to claim 1, wherein the rebounding roller retaining structure is a ball positioned on an outer side of the recess and being pretensioned by a spring, wherein the ball mates with a hollow structure on the end surface of the axel end.

8. Mecanum wheel according to claim 1, wherein the mounting unit recess is a U-shape structure for receiving the axel end.

9. Mecanum wheel according to claim 4, wherein both axel ends of each roller comprises a gripping zone for robotic removal of the roller from the roller mounting units.

10. Mecanum wheel according to claim 4, wherein the deflective arm is provided with a finger grip to ease manual release of the roller.

11. Mecanum wheel according to claim 5, wherein the end surface of both axel ends of each roller comprises a gripping zone for robotic removal of the roller from the roller mounting units.

12. Mecanum wheel according to claim 1, wherein the axial stopper surface 18 is the outward facing largely vertical end surface of the axial end interacting with an inward facing vertical stopper surface on an outer side of the recess constituting the mounting unit stopper surface.

13. Mecanum wheel according to claim 1, wherein the axial stopper surface is a flange at the outward facing inner side of the axial end interacting with an inward facing vertical inner rim of the recess constituting the mounting unit stopper surface.

14. A rolling device for movement along a surface wherein the rolling device comprises:
a housing arranged for attachment to the device,
a mecanum wheel according to claim 1,
driving means.
